(19) United States
(12) Patent Application Publication
(10) Pub. No.: US 2009/0315235 A1
(43) Pub. Date: Dec. 24, 2009

(54) AXIAL SHEAR-LEG ISOLATOR

(75) Inventor: Troy P. Rodecker, Berlin Heights, OH (US)

Correspondence Address: HARNESS, DICKEY & PIERCE, P.L.C., P.O. BOX 828, BLOOMFIELD HILLS, MI, 48303, US

(73) Assignee: THE PULLMAN COMPANY, Milan, OH (US)

(21) Appl. No.: 12/142,859

(22) Filed: Jun. 20, 2008

(51) Int. Cl. F16F 1/40

(52) U.S. Cl. 267/294

(57) ABSTRACT

An elastomeric isolator has an elastomeric body which incorporates an inner structural member that extends through an outer structural member. The elastomeric body includes an axial shear leg extending between the inner and outer structural members that undergo shearing stresses during deflection of the elastomeric isolator. The inner structural member includes radial flanges which are axially offset from radial flanges of the outer structural member. The axial shear leg extends between the pair of radial flanges and is bonded to them at a position outside of the outer structural member. With this configuration compression of the shear hub during high loads is avoided.

### FIELD

The present disclosure relates to an isolator such as an automotive exhaust system isolator. More particularly, the present disclosure relates to an isolator which is configured to provide a very soft on-center rate but yet have the ability to endure spike durability loads while avoiding compression and tension of the shear legs of the isolator through their axial orientation.

### BACKGROUND

The statements in this section merely provide background information related to the present disclosure and may not constitute prior art.

Typically, automotive vehicles including cars and trucks have an internal combustion engine which is coupled to at least a transmission and a differential for providing power to the drive wheels of the vehicle. An engine exhaust system which typically includes an exhaust pipe, a catalytic converter and a muffler is attached to the engine to quiet the combustion process, to clean the exhaust gases and to route the products of combustion away from the engine to a desired position typically at the rear of the vehicle. The exhaust system is supported by exhaust mounts which are positioned between the exhaust system and the frame or some other supporting structure of the vehicle body. In order to prevent engine vibrations from being transmitted to the car body, the exhaust mounts incorporate flexible members or elastic suspension members to isolate the vehicle's exhaust system from the vehicle's body. In order to effectively isolate the vehicle's exhaust system from the vehicle's body, it is preferred that the isolator include a soft on-center rate of deflection.

The prior art exhaust mounts or isolators have included rubber isolators which are a solid rubber component or a puck that is at least three-quarters of an inch thick and which is provided with at least one pair of apertures extending therethrough. The apertures each receive an elongated metal stud. The metal stud is provided with an enlarged tapered head that can be forced through the aperture in the isolator, but it cannot be readily removed from the isolator. The opposite end of the stud is welded to or otherwise secured to either a support point in the vehicle or to one of the components of the exhaust system.

Other designs for isolators include elastomeric moldings of a spoke design where spokes are loaded in tension and compression and a shear leg design that include a leg that is subjected to shearing in the primary loading direction. Most elastomers which are utilized for exhaust isolators exhibit poor tensile fatigue properties stemming from low tear strength properties. The preferred method to load the elastomeric material is in compression or shear.

The prior art puck design is the simplest design, and as discussed above, two pins are inserted at opposite ends of the elastomer and the loads inflict pure tension on the elastomer cords connecting both ends. While this is typically the lowest cost design, it is also the most abusive to the material. In order to offset the failure risk, flexible and/or rigid bands are typically designed inside or around the outside of the elastomeric puck. The advantage of this design is its ability to swivel about one hanger hole to accommodate large positional tolerances for the hanger.

The prior art spoke design isolators load the elastomeric material in compression and tension. The tensile loading makes the design vulnerable to fractures in overloaded conditions. The stress magnitude is directly proportional to the load divided by the minimum spoke cross-sectional area. An additional requirement of the spoke design is that the mating component or hanger pin be centered within the deflection zone while statically preloaded by the weight of the exhaust system. If it is not, the voids designed into the isolator will be bottomed out or positioned in a groundout condition. This results in the soft on-center rate not being employed, thus defeating the purpose of the isolator.

The prior art shear leg design has a primary loading direction which is typically vertical and a secondary loading direction which is typically lateral. When the shear leg design is loaded in its primary loading direction, the loading method is the preferred shear style loading. In addition, this shear style loading is able to be designed desirably soft. However, the secondary loading direction inflicts tensile compressive stresses which are unfavorable for durability. In addition, the secondary loading direction has a rate that is two to three times stiffer than the primary rate which is also an unfavorable condition.

The continued development of elastomeric mounts has been directed to elastomeric mounts which include a soft on-center rate while avoiding the undesirable tension loading of the elastomeric bushing and which avoid the compression of the elastomeric portion of the mount which provides the soft on-center rate during peak loading.

### SUMMARY

The present disclosure provides the art with an elastomeric bushing which uses radial loading to avoid the tension stress loading of the bushing. The radial loading cause shear stresses of the elastomeric bushing regardless of the direction of the loading. The portion of the elastomeric bushing which undergoes shear loading is located outside of the reinforcing brackets that resist peak loading. Thus, during peak loading, compression of this portion of the elastomeric bushing is also avoided.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### DRAWINGS

The present disclosure will become more fully understood from the detailed description and the accompanying drawings, wherein:

FIG. 1 is a perspective view of an elastomeric isolator in accordance with the present disclosure;

FIG. 2 is a cross-sectional view of the elastomeric isolator illustrated in FIG. 1;

FIG. 3 is a perspective view partially in cross-section illustrating the inner metal of the elastomeric isolator illustrated in FIG. 1;

FIG. 4A is a perspective view illustrating the insert for the elastomeric isolator illustrated in FIG. 1;

FIG. 4B is a perspective view illustrating an insert for the elastomeric isolator in accordance with another embodiment of the disclosure;

FIG. 5 is a perspective view of an exhaust system which incorporates the unique exhaust isolators in accordance with the present disclosure;

FIG. 6 is a perspective view of an elastomeric isolator in accordance with the present disclosure;

FIG. 7 is a cross-sectional view of the elastomeric isolator illustrated in FIG. 6;

FIG. 8 is a perspective view partially in cross-section illustrating the inner metal of the elastomeric isolator illustrated in FIG. 6;

FIG. 9 is a perspective view illustrating the insert for the elastomeric isolator illustrated in FIG. 6;

FIG. 10 is a perspective view of an elastomeric isolator in accordance with the present disclosure;

FIG. 11 is a cross-sectional view of the elastomeric isolator illustrated in FIG. 10; and

FIG. 12 is a perspective view illustrating the insert for the elastomeric isolator illustrated in FIG. 10.

### DESCRIPTION

The following description of the preferred embodiment(s) is merely exemplary in nature and is in no way intended to limit the disclosure, its application, or uses.

Referring now to the drawings, there is shown in FIG. 5 an exhaust system which includes the exhaust system isolators in accordance with the present disclosure and which is designated generally by the reference numeral 10. A typical vehicle comprises an internal combustion engine (not shown), a body (not shown), a suspension system (not shown) and exhaust system 10 which is attached to the internal combustion engine and which is supported typically beneath the vehicle. The internal combustion engine is designed to power one or more drive wheels of the vehicle and the exhaust system routes the products of combustion to a desired exhaust location around the outside of the vehicle.

Exhaust system 10 comprises an intermediate pipe 12, a muffler 14, a tailpipe 16 and a plurality of isolator assemblies of various designs. Intermediate pipe 12 is typically connected to the engine or to a catalytic converter (not shown) which is then attached to an exhaust pipe which extends between the engine and the catalytic converter. The catalytic converter may be attached to a single exhaust pipe which leads to a single exhaust manifold or the catalytic converter can be attached to a branched exhaust pipe which leads to a plurality of exhaust pipes which lead to a plurality of exhaust manifolds. Also, intermediate pipe 12 can be attached to a plurality of catalytic converters which connect together prior to reaching muffler 14 using intermediate pipe 12 or the vehicle can have a plurality of exhaust pipes, a plurality of catalytic converters, a plurality of intermediate pipes 12 and a plurality of mufflers 14 which connect together using a single or multiple tailpipes 16. In addition, the exhaust system isolator of the present disclosure is applicable to any type of exhaust system including but not limited to dual exhaust systems which have two separate parallel exhaust systems extending from the internal combustion system.

Exhaust system 10 is utilized to route the exhaust gases from the engine to a desired location around the outside of the vehicle. While traveling through the exhaust system, the catalytic converter cleans the exhaust gases and muffler 14 quiets the noise created during the combustion process in the engine. The present disclosure is directed toward the exhaust system isolators which mount exhaust system 10 to the vehicle while at the same time, isolate the movement of exhaust system 10 with respect to the vehicle.

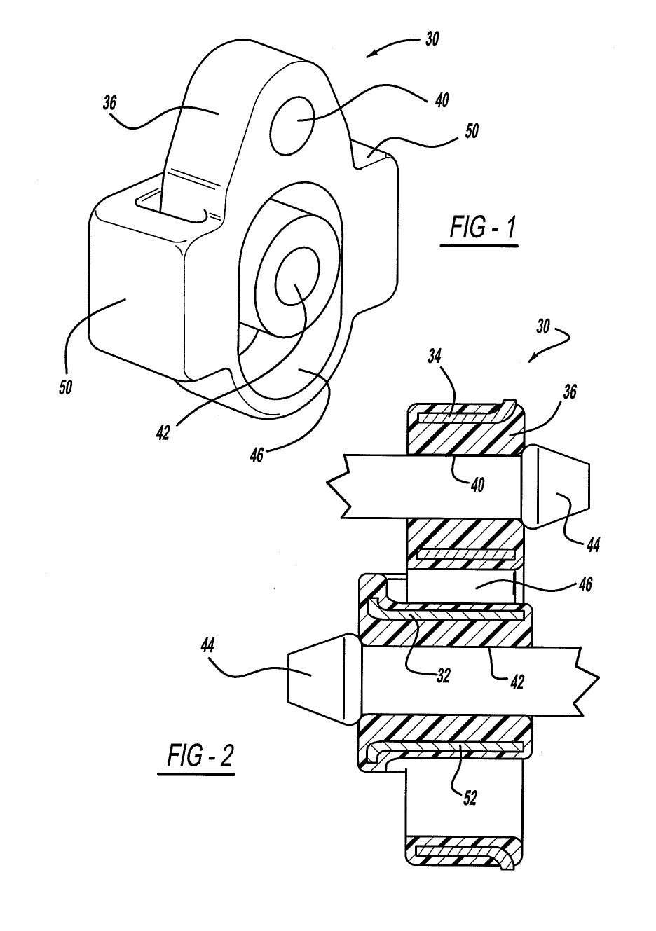

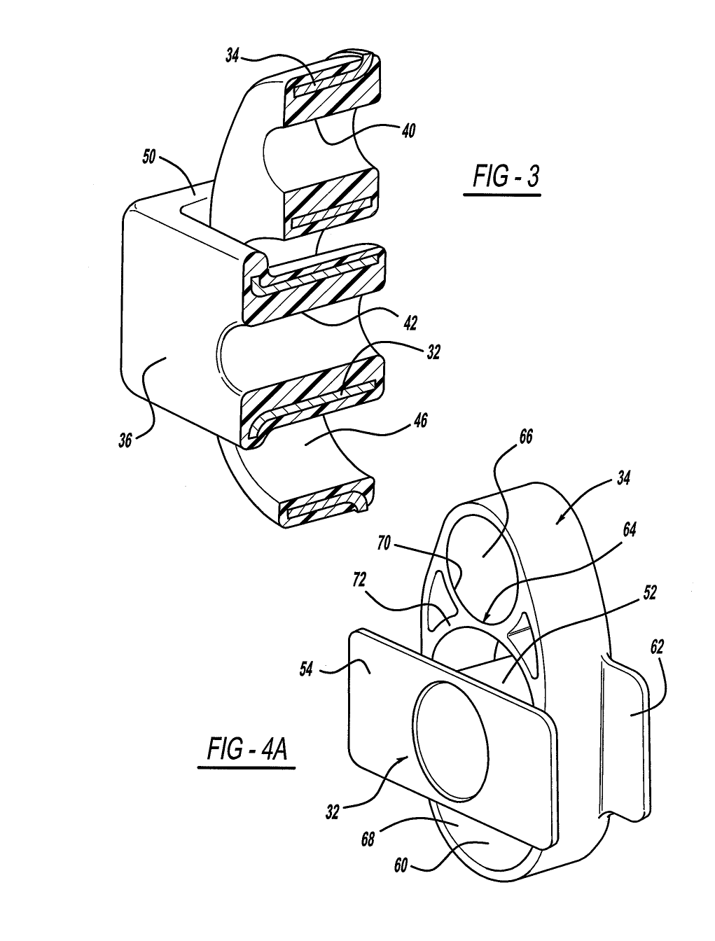

Referring now to FIGS. 1-4B, an exhaust system isolator 30 is disclosed. Exhaust system isolator 30 comprises an inner structural member 32, an outer structural member 34 and an elastomeric body 36.

Elastomeric body 36 defines a first bore 40 and a second bore 42, each of which is designed as a structural member to accept an inner tube, a bolt or a hanger pin 44. One hanger pin 44 is attached to a structural component of the vehicle and one hanger pin 44 is attached to a component of exhaust system 10.

Elastomeric body 36 defines a circumferential void 46 which is located below first bore 40 and which extends through elastomeric body 36. The portion of elastomeric body 36 that forms second bore 42 defines circumferential void 46. The design of circumferential void 46 and the design of the portion of elastomeric body 36 that forms second bore 42 will determine the amount of travel of second bore 42 with respect to first bore 40 until the load to radially deflect exhaust system isolator 30 spikes up due to the closing of circumferential void 46 or the gap between the portion of elastomeric body 36 that defines second bore 42 and the portion of elastomeric body 36 that encases outer structural member 34. Until circumferential void 46 or this gap is closed, radial movements of second bore 42 with respect to first bore 40 cause pure shear in elastomeric body 36 regardless of the loading direction. This shear loading occurs in a pair of axial shear legs 50 defined by elastomeric body 36 which are disposed between outer structural member 34 and inner structural member 32 as discussed below. Tuning for rate and deflection in selected directions can be accomplished independently from other directions by altering the design of elastomeric body 36 using different shaped voids, additional voids, different shapes for elastomeric body 36 and by other means known well in the art.

As can be seen from the figures, the portion of elastomeric body 36 which forms second bore 42 is attached to the portion of elastomeric body 36 which forms first bore 40 and circumferential void 46 by the pair of axial shear legs 50. During movements of exhaust system isolator 30, axial shear legs 50 are loaded in shear. During larger movements of exhaust system isolator 30, the gap between the portion of elastomeric body 36 forming second bore 42 and the portion of elastomeric body 36 forming circumferential void 46 closes. At this point in time, the rate of deflection of exhaust system isolator 30 spikes up because the load is now being resisted by inner structural member 32 and outer structural member 34 rather than by axial shear legs 50. One of the advantages for exhaust system isolator 30 is that when this gap is closed, there is no direct tension or compression of axial shear legs 50.

Inner structural member 32 is a metal or plastic component which comprises a generally cylindrical center portion 52 and a flange portion 54 attached to one end of generally cylindrical center portion 52. Generally cylindrical center portion 52 extends over second bore 42 and flange portion 54 extends radially outward from diametrically opposite sides of generally cylindrical center portion 52. Each side of flange portion 54 provides a base for a respective axial shear leg 50. Elastomeric body 36 encapsulates inner structural member 32 and is bonded to inner structural member 32 including axial shear legs 50 being bonded to flange portion 54.

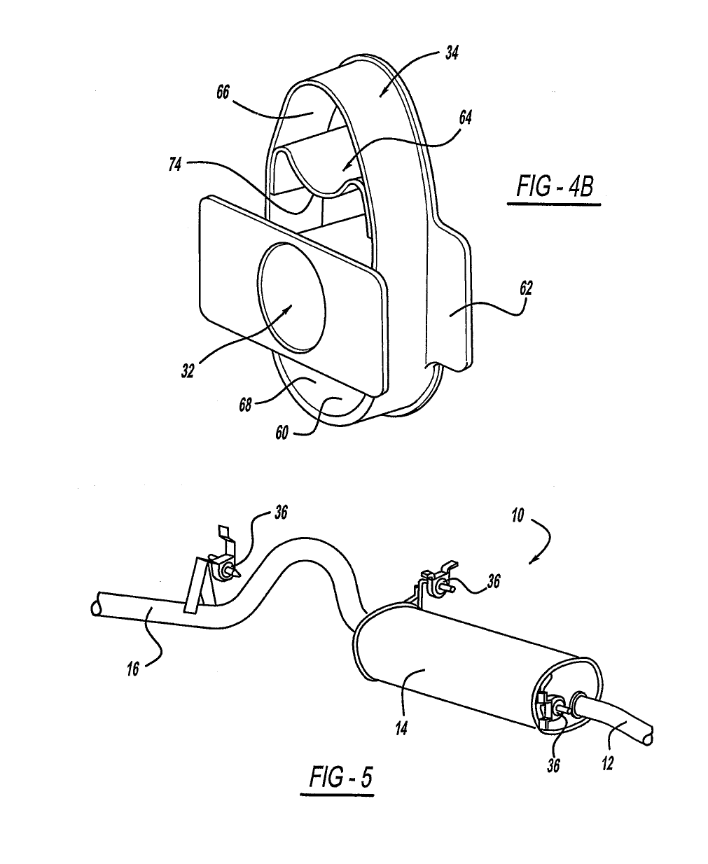

Outer structural member 34 is a metal or plastic component which comprises an annular main portion 60 having a pair of flanges 62 extending radially outward from opposite sides of main portion 60 and a partition wall 64 which divides the center of main portion 60 into an upper cylindrical portion 66 and a central aperture 68. As illustrated in FIG. 4A, partition wall 64 comprises two walls 70 and 72 which meet at their center points. As illustrated in FIG. 4B, partition wall 64 comprises a single wall 74. Upper cylindrical portion 66 of main portion 60 surrounds first bore 40 to provide support for holding hanger pin 44. Central aperture 68 of main portion 60 defines circumferential void 46 and the portion of main portion 60 that forms central aperture 68 provides support for contact between inner structural member 32 and outer structural member 34. Each flange 62 is disposed opposite to a respective side of flange portion 54 to provide a base for a respective axial shear leg 50. Elastomeric body 36 encapsulates outer structural member 34 and is bonded to outer structural member 34 including axial shear legs 50 being bonded to flanges 62.

Axial shear legs 50 are arranged in an axial direction of exhaust system isolator 30 such that any radial loading from the application causes shear stress in axial shear legs 50. In addition, axial shear legs 50 are not disposed between portions of inner structural member 32 and outer structural member 34 which will contact each other during peak loading. Thus, during peak loadings, axial shear legs 50 are not compressed between inner structural member 32 and outer structural member 34.

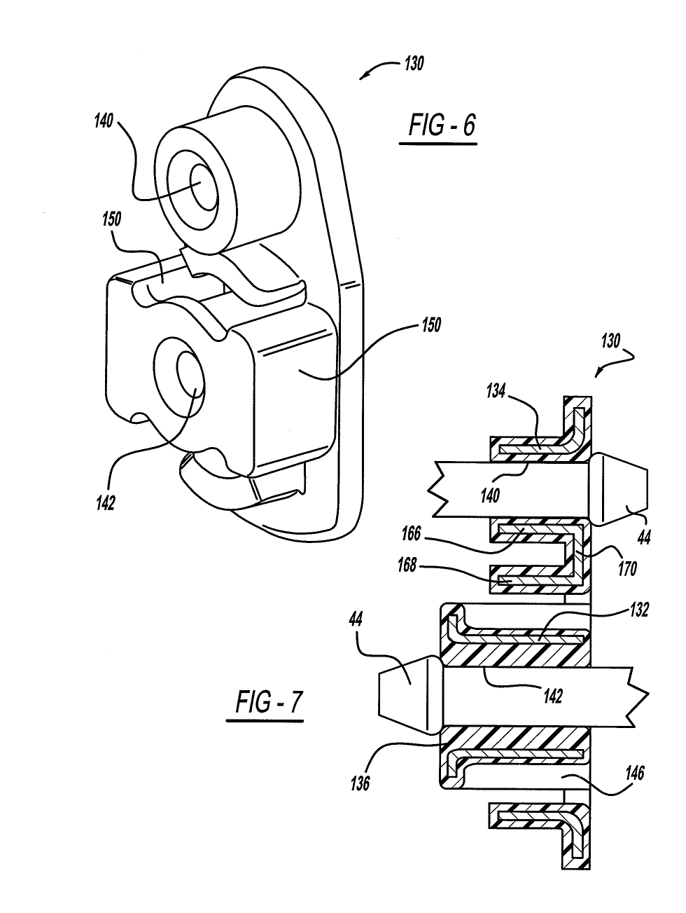

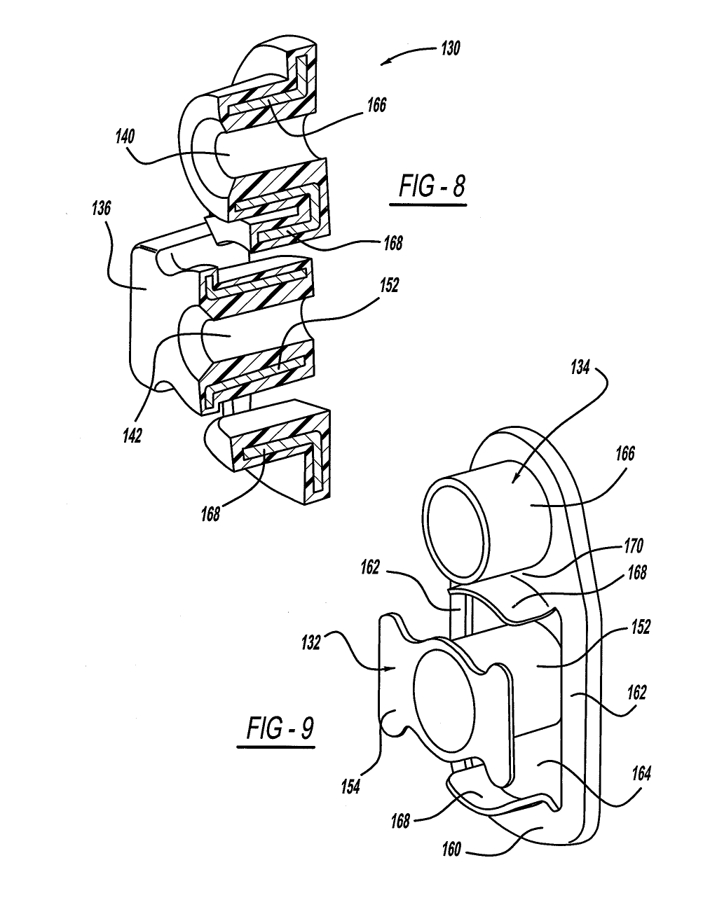

Referring now to FIGS. 6-9, an exhaust system isolator 130 is disclosed. Exhaust system isolator 130 comprises an inner structural member 132, an outer structural member 134 and an elastomeric body 136.

Elastomeric body 136 defines a first bore 140 and a second bore 142, each of which is designed as a structural member to accept an inner tube, a bolt or a hanger pin 44. One hanger pin 44 is attached to a structural component of the vehicle and one hanger pin 44 is attached to a component of exhaust system 10.

Elastomeric body 136 defines a circumferential void 146 which is located below first bore 140 and which extends through elastomeric body 136. The portion of elastomeric body 136 that forms second bore 142 defines circumferential void 146. The design of circumferential void 146 and the design of the portion of elastomeric body 136 that forms second bore 142 will determine the amount of travel of second bore 142 with respect to first bore 140 until the load to radially deflect exhaust system isolator 130 spikes up due to the closing of circumferential void 146 or the gap between the portion of elastomeric body 136 that defines second bore 142 and the portion of elastomeric body 136 that encases outer structural member 134. Until circumferential void 146 or this gap is closed, radial movements of second bore 142 with respect to first bore 140 cause pure shear in elastomeric body 136 regardless of the loading direction. This shear loading occurs in a pair of axial shear legs 150 defined by elastomeric body 136 which are disposed between outer structural member 134 and inner structural member 132 as discussed below. Tuning for rate and deflection in selected directions can be accomplished independently from other directions by altering the design of elastomeric body 136 using different shaped voids, additional voids, different shapes for elastomeric body 136 and by other means known well in the art.

As can be seen from the figures, the portion of elastomeric body 136 which forms second bore 142 is attached to the portion of elastomeric body 136 which forms first bore 140 and circumferential void 146 by the pair of axial shear legs 150. During movements of exhaust system isolator 130, axial shear legs 150 are loaded in shear. During larger movements of exhaust system isolator 130, the gap between the portion of elastomeric body 136 forming second bore 142 and the portion of elastomeric body 136 forming circumferential void 146 closes. At this point in time, the rate of deflection of exhaust system isolator 130 spikes up because the load is now being resisted by inner structural member 132 and outer structural member 134 rather than axial shear legs 150. One of the advantages for exhaust system isolator 130 is that when this gap is closed, there is no direct tension or compression of axial shear legs 150.

Inner structural member 132 is a metal or plastic component which comprises a generally cylindrical center portion 152 and a flange portion 154 attached to one end of generally cylindrical center portion 152. Generally cylindrical center portion 152 extends over second bore 142 and flange portion 154 extends radially outward from diametrically opposite sides of generally cylindrical center portion 152. Each side of flange portion 154 provides a base for a respective axial shear leg 150. Elastomeric body 136 encapsulates inner structural member 132 and is bonded to inner structural member 132 including axial shear leg 150 being bonded to flange portion 154.

Outer structural member 134 is a metal or plastic component which comprises a main portion 160 having a pair of generally planar walls or flanges 162 which define and radially extend out from a central aperture 164, an axially extending cylindrical section 166 which surrounds first bore 140 to provide support for holding hanger pin 44, a pair of axially extending stops 168 which limit the travel of inner structural member 132 with respect to outer structural member 134 and a partition wall 170 disposed between axially extending cylindrical section 166 and central aperture 164. Each planar wall or flange 162 is disposed opposite to a respective side of flange portion 154 to provide a base for a respective axial shear leg 150. Elastomeric body 136 encapsulates outer structural member 134 and is bonded to outer structural member 134 including axial shear legs 150 being bonded to generally planar walls or flanges 162.

Axial shear legs 150 are arranged in an axial direction of exhaust system isolator 130 such that any radial loading from the application causes shear stress in axial shear legs 150. In addition, axial shear legs 150 are not disposed between portions of inner structural member 132 and outer structural member 134 which will contact each other during peak loading. Thus, during peak loadings, axial shear legs are not compressed between inner structural member 132 and outer structural member 134.

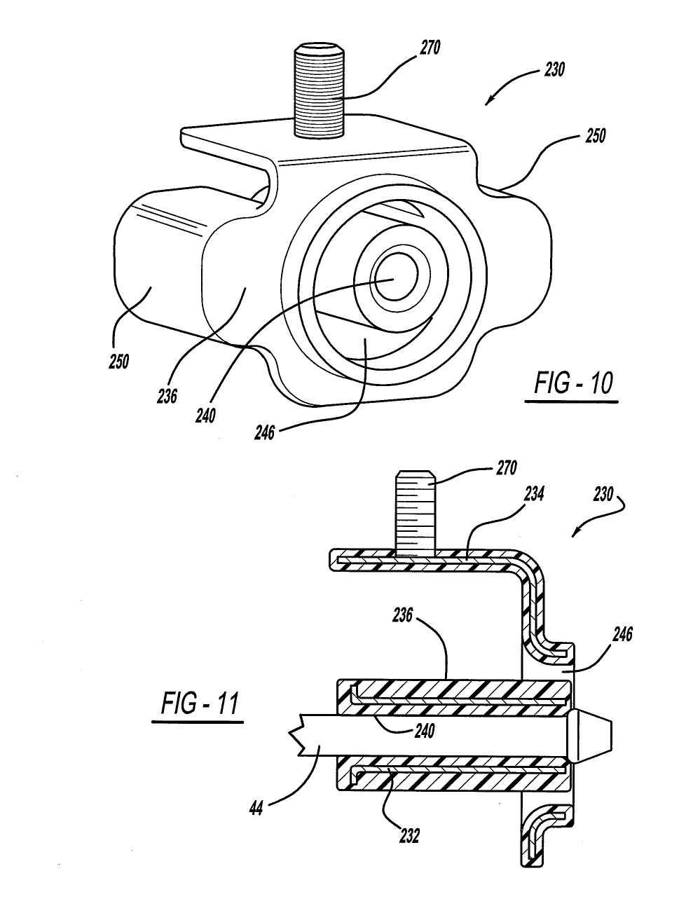

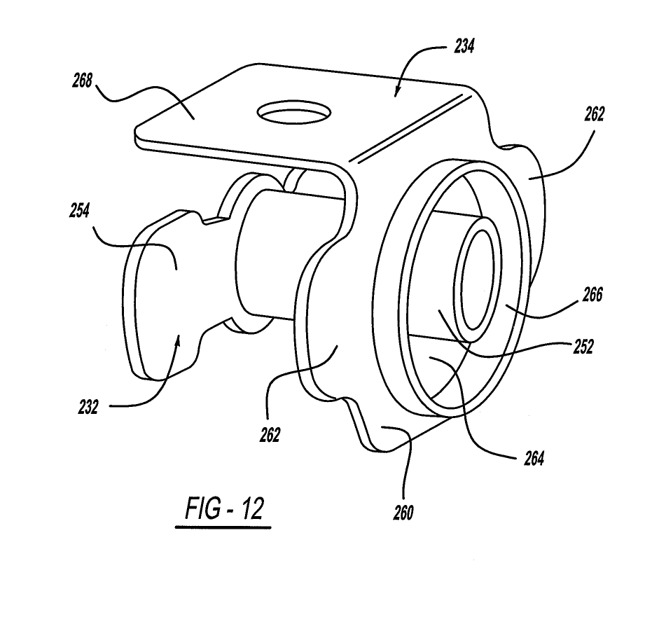

Referring now to FIGS. 10-12, an exhaust system isolator 230 is disclosed. Exhaust system isolator 230 comprises an inner structural member 232, an outer structural member 234 and an elastomeric body 236.

Elastomeric body 236 defines a bore 240 which is designed as a structural member to accept an inner tube, a bolt or a hanger pin 44. Hanger pin 44 is attached to either a structural component of the vehicle or hanger pin 44 is attached to a component of exhaust system 10.

Elastomeric body 236 defines a circumferential void 246 which is located around bore 240 and which extends through elastomeric body 236. The design of circumferential void 246 will determine the amount of travel of bore 240 until the load to radially deflect exhaust system isolator 230 spikes up due to the closing of circumferential void 246. Until circumferential void 246 or this gap is closed, radial movements of bore 240 cause pure shear in elastomeric body 236 regardless of the loading direction. This shear loading occurs in a pair of axial shear legs 250 defined by elastomeric body 236 which are disposed between outer structural member 234 and inner structural member 232 as discussed below. Tuning for rate and deflection in selected directions can be accomplished independently from other directions by altering the design of elastomeric body 236 using different shaped voids, additional voids, different shapes for elastomeric body 236 and by other means known well in the art.

As can be seen from the figures, the portion of elastomeric body 236 which defines the outer wall of void 246 is attached to the portion of elastomeric body 236 which forms bore 240 by the pair of axial shear legs 250. During movements of exhaust system isolator 230, axial shear legs 250 are loaded in shear. During larger movements of exhaust system isolator 230, the gap between the portion of elastomeric body 236 forming the outer wall defining void 246 and the portion of elastomeric body 236 forming bore 240 closes. At this point in time, the rate of deflection of exhaust system isolator 230 spikes up because the load is now being resisted by inner structural member 232 and outer structural member 234 rather than axial shear legs 250. One of the advantages for exhaust system isolator 230 is that when this gap is closed, there is no direct tension or compression of axial shear legs 250.

Inner structural member 232 is a metal or plastic component which comprises a generally cylindrical center portion 252 and a flange portion 254 attached to one end of generally cylindrical center portion 252. Generally cylindrical center portion 252 extends over bore 240 and flange portion 254 extends radially outward from diametrically opposite sides of generally cylindrical center portion 252. Each side of flange portion 254 provides a base for a respective axial shear leg 250. Elastomeric body 236 encapsulates inner structural member 232 and is bonded to inner structural member 232 including axial shear leg 250 being bonded to flange portion 254.

Outer structural member 234 is a metal or plastic component which comprises a main portion 260 having a pair of generally planar walls or flanges 262 which define and radially extend out from a central aperture 264, an axially extending cylindrical section 266 which surrounds bore 240 to provide a stop for bore 240 and an axially extending planar wall 268 which extends generally perpendicular to main portion 260 and includes a mounting stud 270 extending generally perpendicular to planar wall 268. While planar wall 268 is disclosed as being generally perpendicular to main portion 260, it is within the scope of the present disclosure to have planar wall 268 extend at any angle with respect to main portion 260. Also, while mounting stud 270 is disclosed as a threaded mounting stud, it is within the scope of the present disclosure to design mounting stud 270 such that any other fastening means known in the art can be combined or mated with mounting stud 270. Each planar wall or flange 262 is disposed opposite to a respective side of flange portion 254 to provide a base for a respective axial shear leg 250. Elastomeric body 236 encapsulates outer structural member 234 and is bonded to outer structural member 234 including axial shear legs 250 being bonded to generally planar walls or flanges 262.

Axial shear legs 250 are arranged in an axial direction of exhaust system isolator 230 such that any radial loading from the application causes shear stress in axial shear legs 250. In addition, axial shear legs 250 are not disposed between portions of inner structural member 232 and outer structural member 234 which will contact each other during peak loading. Thus, during peak loadings, axial shear legs are not compressed between inner structural member 232 and outer structural member 234.

The mounting system for exhaust system isolator 30 exhaust system isolator 130 or exhaust system isolator 230 is not limited to hanger pins 44 illustrated above or hanger pins and a stud as illustrated above. Any of the mounting systems disclosed in Applicant's co-pending application Ser. No. 11/233,283, the disclosure of which is incorporated herein by reference, could be used to mount exhaust system isolator 30, 130 or 230 to the vehicle by changing main portion 60, 160 or 260 of exhaust system isolator 30, 130 or 230 to the mounting systems disclosed in the co-pending application.

What is claimed is:

1. An isolator comprising:
an elastomeric body;
an outer structural member attached to said elastomeric body, said outer structural member having a main portion defining a central aperture and a pair of outer flanges extending outward from said central aperture; and
an inner structural member attached to said elastomeric body, said inner structural member having a generally cylindrical center portion and a pair of inner flanges extending radially from said generally cylindrical center portion; wherein
said elastomeric body extends between each of said pair of inner flanges and a respective outer flange.

2. The isolator according to claim 1, wherein each of said pair of inner flanges is axially opposed to a respective outer flange.

3. The isolator according to claim 2, wherein said elastomeric body defines an axial shear leg extending between each of said axially opposed flanges.

4. The isolator according to claim 1, wherein said elastomeric body defines a circumferential void, an axial shear leg being defined by said elastomeric body at a position radially outward from said circumferential void.

5. The isolator according to claim 1, wherein said outer structural member includes a partition wall that divides said outer structural member into an upper cylindrical portion and a lower portion defining said central aperture.

6. The isolator according to claim 5, wherein said elastomeric body defines a first mounting bore extending through said upper cylindrical portion and a second mounting bore extending through said lower portion.

7. The isolator according to claim 6, wherein said center cylindrical portion of said inner structural member is disposed around said second mounting bore.

8. The isolator according to claim 7, wherein each of said pair of inner flanges is axially opposed to a respective outer flange.

9. The isolator according to claim 8, wherein said elastomeric body defines an axial shear leg extending between each of said axially opposed flanges.

10. The isolator according to claim 1, wherein said elastomeric body defines an axial shear leg extending between each of said pair of inner flanges and a respective outer flange.

11. The isolator according to claim 10, wherein said axial shear legs are disposed radially outward from said central aperture of said outer structural member.

12. The isolator according to claim 10, wherein each of said axial shear legs is bonded to said axially opposed flanges.

13. The isolator according to claim 10, wherein said elastomeric body defines a circumferential void, an axial shear leg being defined by said elastomeric body at a position radially outward from said circumferential void.

14. The isolator according to claim 10, wherein said outer structural member includes a partition wall that divides said central aperture into an upper portion and a lower portion.

15. The isolator according to claim 14, wherein said elastomeric body defines a first mounting bore extending through said upper portion and a second mounting bore extending through said lower portion.

16. The isolator according to claim 15, wherein said center portion of said inner structural member is disposed around said second mounting bore.

17. The isolator according to claim 10, wherein said outer structural member includes a planar wall extending from said main portion of said outer structural member.

18. The isolator according to claim 17, wherein said outer structural member includes a mounting stud extending from said planar wall.

19. An isolator comprising:
a first structural member adapted to attach said isolator to a first component;
a second structural member adapted to attach said isolator to a second component; and
an elastomeric body disposed between said first structural component and said second structural component; wherein
movement of said first structural component with respect to said second structural component creates shear stress in said elastomeric body.

20. The isolator according to claim 19, wherein said first structural member defines a generally cylindrical section having an axis, movement of said first structural member in a direction generally perpendicular to said axis creating shear stress in said elastomeric body.
